(19) United States
(12) Patent Application Publication
(10) Pub. No.: US 2012/0266975 A1
(43) Pub. Date: Oct. 25, 2012

(54) CLOSABLE THROUGHFLOW MEMBER

(76) Inventor: Frank Kelly, Defford (GB)

(21) Appl. No.: 13/261,287

(22) PCT Filed: Nov. 1, 2010
(86) PCT No.: PCT/EP2010/066571

§ 371 Date: Jun. 25, 2012

(30) Foreign Application Priority Data
Nov. 9, 2009 (GB) 0919555.3

(51) Int. Cl. F16L 5/00

(52) U.S. Cl. 137/357

(57) ABSTRACT

A closable throughflow member comprises a housing (1, 101) which defines a flow path for moisture and/or liquid through the housing. A check valve (17, 117) is provided within the housing and is adapted to close in the event of substantial liquid flow in one direction.

This invention relates to a closable throughflow member such as a closable weep hole or a closable cowl.

Weep holes are conventionally provided in walls, for example in the walls of buildings, to allow the escape of moisture and water through the wall. However, weep holes are generally overlooked in the event of a flood and can lead to ingress of flood water into a building and serious damage to the building itself and to the contents of the building.

It is known to provide removable covers for weep holes, but such covers are inconvenient to put in place whenever there is a risk of a flood and to remove after the flood danger has diminished.

In addition to providing weep holes through a wall of a building, there is a further problem with openings in building walls and the like, including air bricks, grilles and vents. It is known to provide cowls over such openings, but cowls only protect against water entry during inclement weather such as rain and/or strong winds. In the event of a flood, water would flow behind the protective front wall of the cowl and enter the building through the opening. It is therefore desirable to provide a cowl which prevents the entry of water through such an opening, while not restricting the opening under normal circumstances.

It is therefore an object of the present invention to provide a closable throughflow member such as a closable weephole or a closable cowl which overcomes, or at least ameliorates, the problems associated with known such throughflow members.

According to the present invention there is provided a closable throughflow member comprising a housing defining a flow path for moisture and/or liquid therethrough, and a check valve provided within the housing and adapted to close in the event of substantial liquid flow in one direction.

The housing may include an opening in a front region thereof which may be covered with a mesh for excluding insects from the housing.

The housing may include an opening in a rear region thereof which may be covered with a mesh for excluding insects from the housing.

The valve may be a pivotable flap valve. The valve may include a valve plate pivotably mounted along an upper edge thereof and bearing on the base of the housing along a lower edge thereof. The lower edge of the valve plate may be chamfered. Alternatively, the valve may include a valve plate pivotably mounted about a lower edge thereof and bearing in use against a sealing lip formed on an internal face of the top of the housing. In such a case the specific gravity of the valve plate may be less than that of water. The sealing lip may additionally be formed on side walls of the housing. As a further alternative, the valve may include a valve plate pivotably mounted in the region of one of the front and the rear of the housing and bearing in use against a sealing lip formed on an internal face of the other of the front and rear of the housing. In such a case, the specific gravity of the valve plate may be less than that of water. The sealing lip may additionally be formed on side walls of the housing. The valve plate may include a substantially cylindrical portion extending across an edge of the valve plate and received in a complementary recess in a receiving portion forming part of the housing.

The closable member may comprise a weep hole.

The housing of the weep hole may be substantially rectangular. The substantially rectangular housing may include an inclined front wall, the opening in the region of the front of the housing being formed in the base of the housing beneath the inclined front wall. A downwardly extending projection may be provided on that side of the opening remote from the front wall. The housing may include an inclined internal wall defining the flow path through the housing, the flow path being narrower in the region of the front of the housing than in the region of the rear of the housing. The receiving portion may be formed as part of the inclined wall. Alternatively, the front and rear of the housing may be open. The housing may be provided with one or more internal lips extending around the periphery of the housing so as to minimise the flow of liquid through the housing. The housing may be provided with one or more ribs extending externally around the periphery of the housing to minimise the flow of liquid externally along the housing.

Alternatively, the housing of the weep hole may be substantially triangular the housing having a relatively low front region and a relatively large rear region. The opening at the front region of the housing may be provided in the front wall thereof. The inclined wall of the housing may be provided with one or more projections to assist securing the housing in a wall of a building. The receiving portion may be formed as part of an inclined external wall of the housing.

Alternatively, the closure member may comprise a cowl.

The housing of the cowl may have an inclined front and an upright rear with a front opening below the front thereof. The housing may be provided with a peripheral flange for securing the cowl over an opening in a wall.

For a better understanding of the present invention and to show more clearly how it may be carried into effect reference will now be made, by way of example, to the accompanying drawings in which:

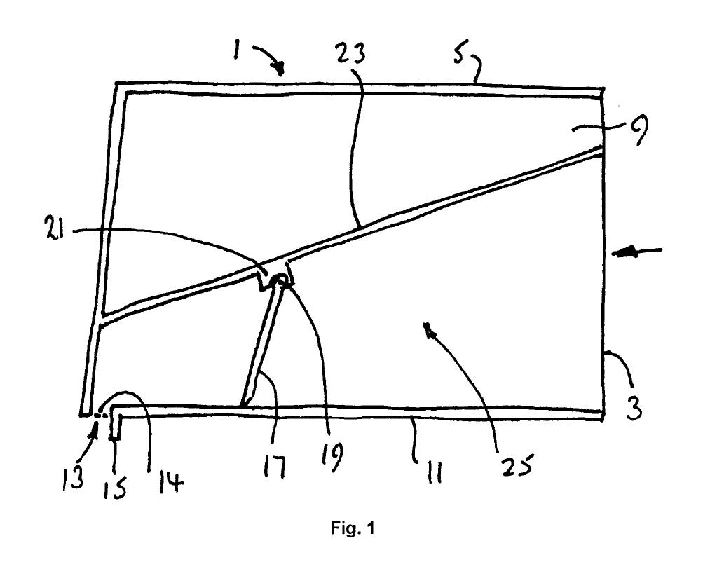

FIG. 1 is a side view of one embodiment of a closable weep hole according to the present invention, with part removed for clarity;

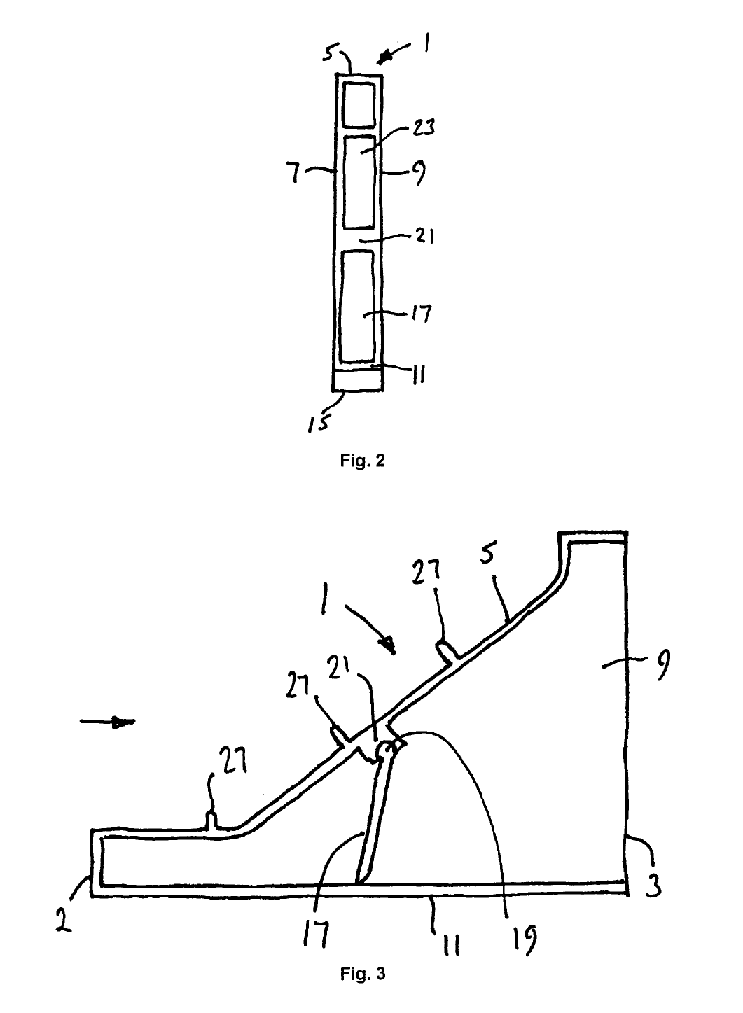

FIG. 2 is a view in the direction of the arrow shown in FIG. 1;

FIG. 3 is a side view of another embodiment of a closable weep hole according to the present invention, with part being removed for clarity;

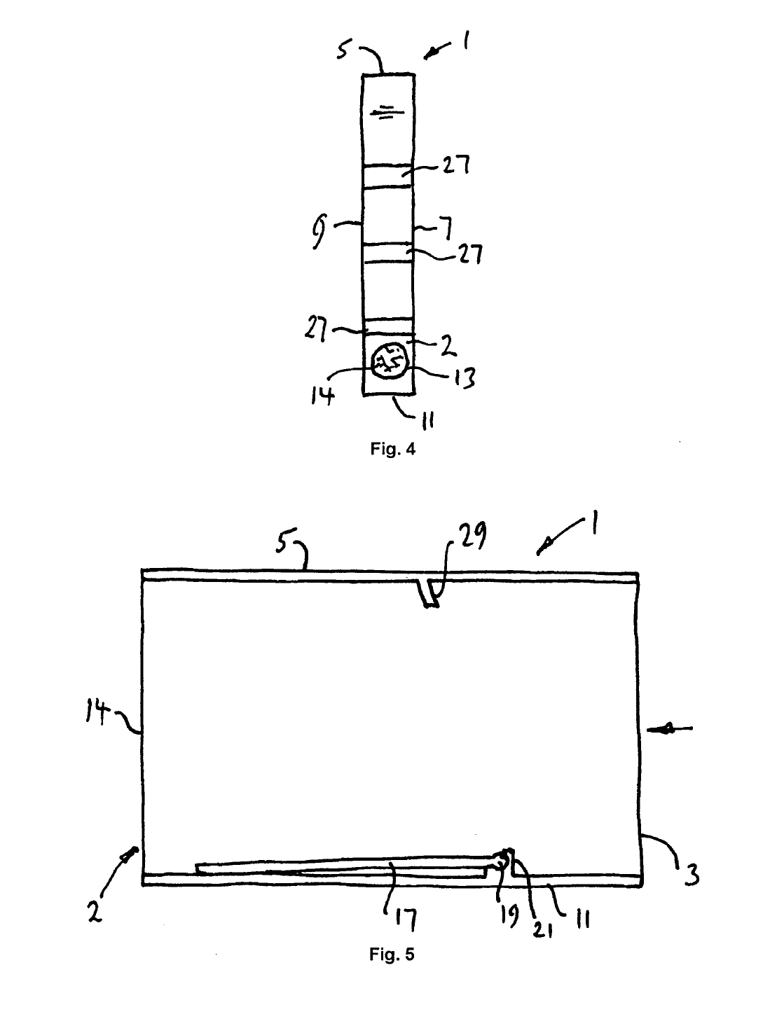

FIG. 4 is a view in the direction of the arrow in FIG. 3;

FIG. 5 is a side view of a further embodiment of a closable weep hole according to the present invention in a first configuration, with part being removed for clarity;

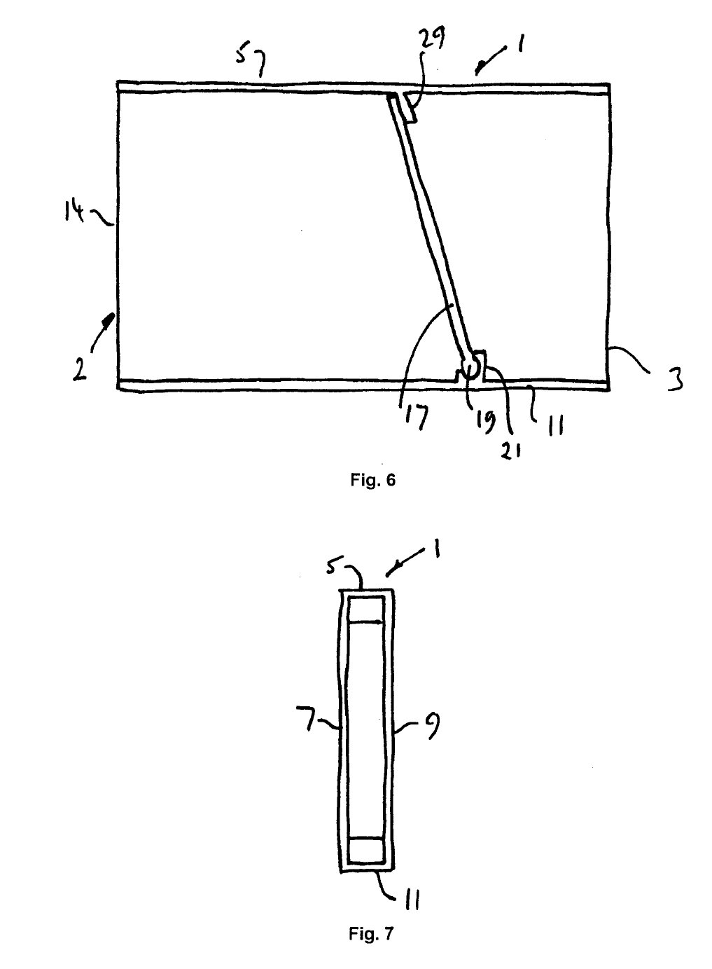

FIG. 6 is a view corresponding to FIG. 5, in a second configuration;

FIG. 7 is a view on a different scale in the direction of the arrow in FIG. 5;

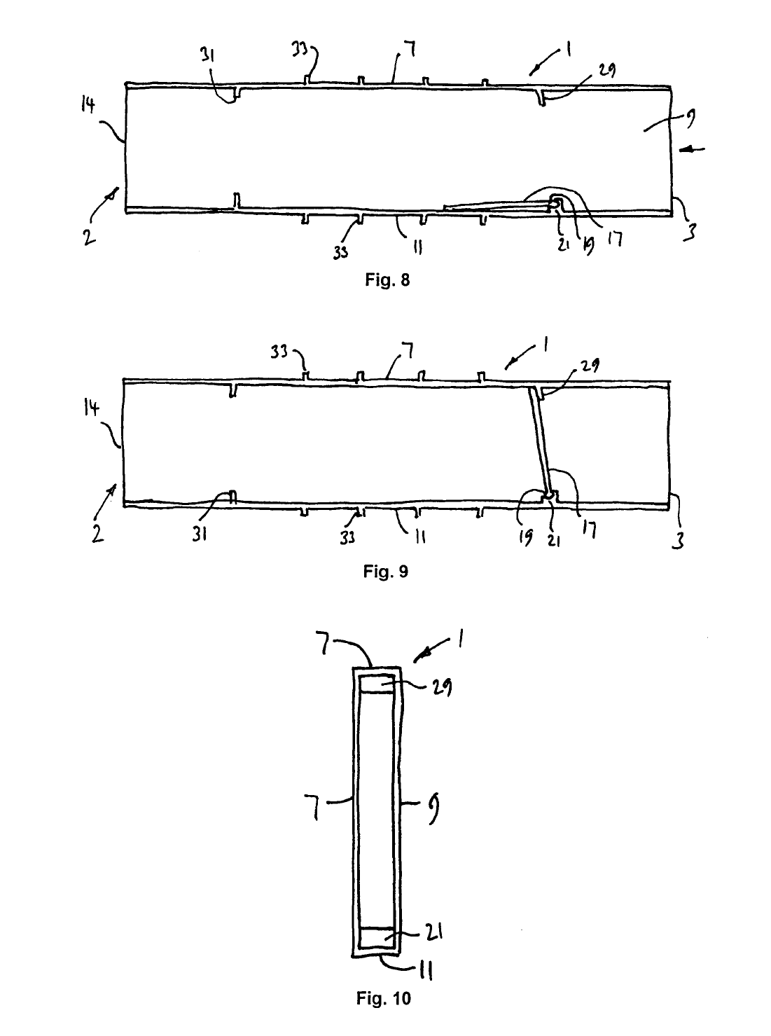

FIG. 8 is a side view of a further embodiment of a closable weep hole according to the present invention in a first configuration, with part being removed for clarity;

FIG. 9 is a view corresponding to FIG. 8, in a second configuration;

FIG. 10 is a view on a different scale in the direction of the arrow in FIG. 8;

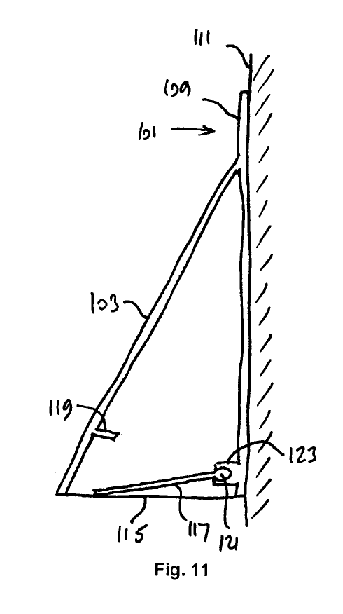

FIG. 11 is a side view of an embodiment of a closable cowl according to the present invention in a first configuration, with part being removed for clarity;

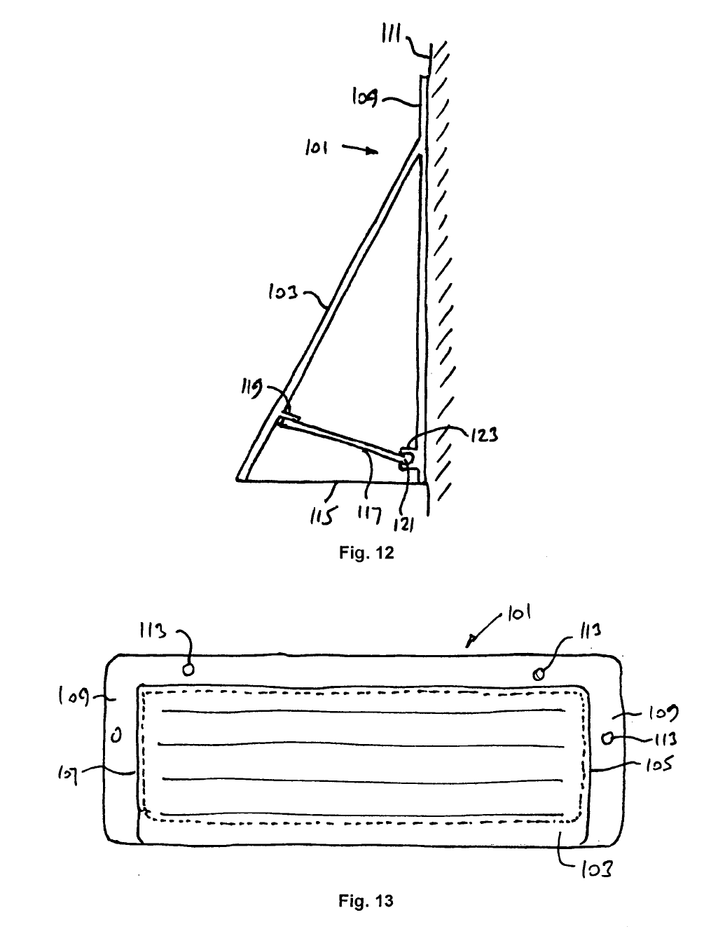

FIG. 12 is a view corresponding to FIG. 11, in a second configuration; and

FIG. 13 is a front view of the closable cowl shown in FIG. 11.

The closable weep hole shown in FIGS. 1 and 2 comprises a substantially rectangular hollow housing 1 which is designed, for example, to be positioned between adjacent bricks in the outer wall of a building, being held in place by mortar or the like. The weep hole may be made, for example, of high impact polystyrene which may be coloured to suit the intended application, such as buff or sand, terracotta or brown. The housing 1 is substantially the height and depth of a conventional brick and of a width so as to fit in the space conventionally provided between adjacent bricks, although the depth of the housing is such that at least a lower portion of the housing protrudes beyond the outer face of the brickwork. This may be accomplished by providing an inclined front wall 2 as part of the housing, with the lower part of the housing extending progressively beyond the outer face of the brickwork, or by dimensioning a rectangular housing such that the entire front wall 2 protrudes beyond the outer face of the brickwork.

The rear 3 of the housing is open, while the front 2 is closed. The top 5 of the housing is also closed as are the sides 7, 9 (only one side being shown in FIG. 1). The base 11 of the housing where it projects beyond the outer face of the brickwork is formed with an opening 13 for the outlet of moisture and/or water. The provision of the opening 13 in the base of the housing 1 reduces the likelihood of ingress of water or moisture in normal use of the weep hole. A projection 15 is provided, extending downwardly from the base 11, to assist positioning the housing 1 in the brickwork and reduces the likelihood of the brickwork becoming stained.

The outlet opening is covered with a mesh 14 to prevent insects and the like entering the housing 1. If desired the rear 3 of the housing may also be covered with mesh.

Mounted within the housing 1 is a flap valve 17. The valve 17 is pivotably mounted at an upper end thereof and in normal use bears lightly against the base of the housing while allowing moisture and liquid to flow through the housing to the outlet opening 13. However, in the event of a flood, when water enters the housing 1 through the opening 13, the pressure of the water urges the flap valve 17 firmly against the base of the housing so as to prevent the ingress of water through the housing and into the building. If desired, the lower edge of the valve may be chamfered to improve sealing with the base of the housing. The valve 17 is provided with a substantially cylindrical portion 19 which extends along the upper edge of the valve and is received in a complementary recess formed in a receiving portion 21 formed within the housing. The recess in the receiving portion is configured to allow pivoting of the valve relative to the housing.

In practice, it is convenient to restrict the space within the housing 1 through which moisture and/or liquid can pass by providing a wall 23 which forms a passage 25 between the opening 13 and the open rear 3 of the housing. The wall 23 is ideally inclined such that the width of the passage is less in the region of the opening 13 than at the rear 3 of the housing. The receiving portion 21 is conveniently formed as part of the wall 23.

The closable weep hole shown in FIGS. 3 and 4 is similar in principle to that described above in relation to FIGS. 1 and 2 and the same references are used to denote the same or similar components. The closable weep hole shown in FIGS. 3 and 4 comprises a housing 1 which is substantially triangular in configuration, but ideally with a portion of constant height in the region of the rear 3 of the housing and a portion of constant height in the region of the front 2 of the housing. The reduced height in the region of the outer face of the brickwork reduces the visual impact of the weep hole. As with the weep hole of FIGS. 1 and 2, the weep hole of FIGS. 3 and 4 is designed, for example, to be positioned between adjacent bricks in the outer wall of a building, being held in position with mortar or the like, the mortar also filling the space the housing does not occupy. The housing 1 at its highest point is substantially the height of a conventional brick and at its deepest point is substantially the depth of a conventional brick. As with the embodiment of FIGS. 1 and 2, the housing is of a width so as to fit in the space conventionally provided between adjacent bricks.

The front 2 and rear 3 of the housing are open. The top 5 and base 11 of the housing are closed as are the sides 7, 9 (only one side being shown in FIG. 3). The front 2 of the housing is formed with an opening 13 for the outlet of moisture and/or water. A plurality of projections 27 is provided, extending upwardly from the top of the housing, to assist securing the housing 1 in the brickwork.

The outlet opening is covered with a mesh 14 to prevent insects and the like entering the housing 1. If desired, the rear of the housing may also be covered with mesh.

Mounted within the housing 1 is a flap valve 17. The valve 17 is pivotably mounted at an upper end thereof to the top wall of the housing in a region where the wall is inclined. In normal use the valve bears lightly against the base of the housing while allowing moisture and liquid to flow through the housing to the outlet opening 13. However, in the event of a flood, when water enters the housing 1 through the opening 13, the pressure of the water urges the flap valve 17 firmly against the base of the housing so as to prevent the ingress of water through the housing and into the building. If desired, the lower edge of the valve may be chamfered to improve sealing with the base of the housing. The valve 17 is provided with a substantially cylindrical portion 19 which extends along the upper edge of the valve and is received in a complementary recess formed in a receiving portion 21 formed within the housing. The recess in the receiving portion is configured to allow pivoting of the valve relative to the housing.

In practice, the receiving portion 21 is conveniently formed as part of the upper inclined wall 5 of the housing.

The closable weep hole shown in FIGS. 5 to 7 is similar to that shown in FIGS. 1 and 2 and the same references are used to denote the same or similar components.

The closable weep hole shown in FIGS. 5 to 7 comprises a substantially rectangular hollow housing 1 which is designed, for example, to be positioned between adjacent bricks in the outer wall of a building, being held in place by mortar or the like. The weep hole may be made, for example, of high impact polystyrene which may be coloured to suit the intended application, such as buff or sand, terracotta, brown, grey or white, or may be substantially colourless. The housing 1 is substantially the height and depth of a conventional brick and of a width so as to fit in the space conventionally provided between adjacent bricks.

The front 2 and rear 3 of the housing are open to allow the outlet of moisture and/or liquid from the building, the front 2 incorporating the opening 13. The top 7 and base 11 of the housing are closed as are the sides 7, 9 (only one side being shown in FIGS. 5 and 6).

The outlet opening 13 at the front 2, and the rear 3, of the housing are covered with a mesh 14 to prevent insects and the like entering the housing 1.

Mounted within the housing 1 is a flap valve 17 which is made of a material having a specific gravity less than that of water. The valve 17 is pivotably mounted at a lower end thereof and in normal use rests against the base of the housing, as shown in FIG. 5, while allowing moisture and liquid to flow through the housing to the outlet opening 13. However, in the event of a flood, when water enters the housing 1 through the opening 13, the flap valve 17, or at least the free end thereof, floats on the water and bears against a sealing lip 29 which is positioned within the top 5 of the housing (and optionally within the sides 7, 9 of the housing), as shown in FIG. 6, to seal the flap valve 17 against the sealing lip 29 so as to prevent the ingress of water through the housing and into the building. The sealing lip 29 may be configured such that it is engaged by the valve 17 before the valve reaches an upright orientation. The valve 17 is provided with a substantially cylindrical portion 19 which extends along the lower edge of the valve and is received in a complementary recess formed in a receiving portion 21 formed on the base 11 of the housing. The recess in the receiving portion is configured to allow pivoting of the valve relative to the housing.

The closable weep hole shown in FIGS. 8 to 10 is similar to that shown in FIGS. 5 to 7 and the same references are used to denote the same or similar components.

The closable weep hole shown in FIGS. 8 to 10 comprises a substantially rectangular hollow housing 1 which is designed, for example, to be positioned between adjacent bricks in the outer wall of a building, being held in place by mortar or the like. The weep hole may be made, for example, of high impact polystyrene which may be coloured to suit the intended application, such as buff or sand, terracotta, brown, grey or white, or may be substantially colourless. The housing 1 is substantially the height of a conventional brick and of a width so as to fit in the space conventionally provided between adjacent bricks. The depth of the housing is such that it will extend in use through the outer brickwork and across a cavity within a wall of a building so as to provide underfloor ventilation within the building.

The front 2 and rear 3 of the housing are open to allow the outlet of moisture and/or liquid from the building, the front 2 incorporating the opening 13. The top 7 and base 11 of the housing are closed as are the sides 7, 9 (only one side being shown in FIGS. 8 and 9).

The outlet opening 13 at the front 2, and the rear 3, of the housing are covered with a mesh 14 to prevent insects and the like entering the housing 1.

Mounted within the housing 1 is a flap valve 17 which is made of a material having a specific gravity less than that of water. The valve 17 is pivotably mounted at a lower end thereof and in normal use rests against the base of the housing, as shown in FIG. 8, while allowing moisture to pass through the housing to the outlet opening 13. However, in the event of a flood, when water enters the housing 1 through the opening 13, the flap valve 17, or at least the free end thereof, floats on the water and, as shown in FIG. 9, bears against a sealing lip 29 which extends around the internal periphery of the housing 1 to seal the flap valve 17 against the sealing lip 29 so as to prevent the ingress of water through the housing and into the building. The sealing lip 29 may be configured such that it is engaged by the valve 17 before the valve 17 reaches an upright orientation. The valve 17 is provided with a substantially cylindrical portion 19 which extends along the lower edge of the valve and is received in a complementary recess formed in a receiving portion constituted by that part of the sealing lip 29 formed on the base 11 of the housing. The recess in the sealing lip is configured to allow pivoting of the valve relative to the housing.

A further lip 31 extends around the internal periphery of the housing 1 between the free end of the valve 17 and the opening 13 in the front wall 2. The lip 31, together with the lip 29, prevent flow of small amounts of liquid through the housing, while not inhibiting the flow of moisture.

A plurality of external ribs 33 extend around the periphery of the housing 1 and inhibit the flow of liquid along the outside of the housing.

Clearly the lip 31 and the ribs 33 can be provided in respect on any of the weep holes described hereinabove.

The cowl shown in FIGS. 11 to 13 comprises a housing 101 which includes a front wall 103, substantially triangular side walls 105, 107 and a flange 109 surrounding the walls and adapted to bear against a wall 111 of a building. The flange 109 also extends along a lower edge of the housing so as to define an opening within the flange which can be arranged around the opening in the building wall. The flange is provided with a number of apertures 113 for securing the cowl to the wall of the building in a watertight manner. The lower face of the cowl is open, but is covered with a mesh 115.

Mounted within the housing is a flap valve 117, of material having a specific gravity less than 1, which is pivotably mounted to a lower region of the flange 109 and in normal use bears against the mesh 115 (or a lower stop (not shown)). However, in the event of a flood, when water enters the housing 101 the valve 117 rises and seals against a sealing lip 119 which extends along the internal face of the front 103 and optionally along the inner faces of the sides 105, 107 to prevent the ingress of water. The valve 117 is formed with a substantially cylindrical portion 121 which is pivotably mounted in a complementary recess formed in a receiving portion 123 formed on the flange 109. As the flood water recedes the valve opens to allow air flow to the opening once again.

1. A closable throughflow member forming a weep hole comprising a housing (1, 101) defining a flow path for moisture and/or liquid there-through, and a check valve (17, 117) provided within the housing and adapted to close in the event of substantial liquid flow in one direction in order to prevent water flowing through the housing in the event of a flood.

2. A throughflow member as claimed in claim 1, wherein the housing (1, 101) includes an opening in a front region (2, 103) thereof which is covered with a mesh (14, 115) for excluding insects from the housing.

3. A throughflow member as claimed in claim 1, wherein the housing (1) includes an opening in a rear region (3) thereof which is covered with a mesh (14) for excluding insects from the housing.

4. A throughflow member as claimed in claim 1, wherein the valve is a pivotable flap valve (17, 117).

5. A throughflow member as claimed in claim 4, wherein the valve (17, 117) includes a valve plate pivotably mounted along an upper edge thereof and bearing on the base of the housing (1, 101) along a lower edge thereof.

6. A throughflow member as claimed in claim 5, wherein the lower edge of the valve plate is chamfered.

7. A throughflow member as claimed in claim 4, wherein the valve (17, 117) includes a valve plate pivotably mounted about a lower edge thereof and bearing in use against a sealing lip (29, 119) formed on an internal face of the top of the housing (1, 101).

8. A throughflow member as claimed in claim 7, wherein the specific gravity of the valve plate (17, 117) is less than that of water.

9. A throughflow valve as claimed in claim 7, wherein the sealing lip (29, 119) is additionally formed on side walls (7, 9) of the housing (1, 101).

10. A throughflow member as claimed in claim 4, wherein the valve (17) includes a valve plate pivotably mounted in the region of one of the front (2) and the rear (3) of the housing (1) and bearing in use against a sealing lip (29) formed on an internal face of the other of the front and rear of the housing.

11. A throughflow member as claimed in claim 10, wherein the specific gravity of the valve plate is less than that of water.

12. A throughflow valve as claimed in claim 10, wherein the sealing lip (29, 119) is additionally formed on side walls (7, 9, 105, 107) of the housing (1, 101).

13. A throughflow member as claimed in claim 4, wherein the flap valve (17, 117) includes a valve plate which includes a substantially cylindrical portion (19, 121) extending across an edge of the valve plate and received in a complementary recess in a receiving portion (21, 123) forming part of the housing (1, 101).

14. (canceled)

15. A throughflow member as claimed in claim 1, wherein the housing (1) of the weep hole is substantially rectangular.

16. A throughflow member as claimed in claim 15, wherein the substantially rectangular housing (1) includes an inclined front wall, an opening (13) in the region of the front (2) of the housing being formed in the base (11) of the housing beneath the inclined front wall.

17. A throughflow member as claimed in claim 16, wherein a downwardly extending projection (15) is provided on that side of the opening (13) remote from the front wall (2).

18. A throughflow member as claimed in claim 1, wherein the housing (1) includes an inclined internal wall (23) defining the flow path (25) through the housing, the flow path being narrower in the region of the front (2) of the housing than in the region of the rear (3) of the housing.

19. A throughflow member as claimed in claim 13, wherein a receiving portion (21) for the valve (17) is formed as part of the inclined wall (23).

20. A throughflow member as claimed in claim 1, wherein the front (2) and rear (3) of the housing (1) are open.

21. A throughflow member as claimed in claim 1, wherein the housing (1) is provided with one or more internal lips (31) extending around the periphery of the housing so as to minimise the flow of liquid through the housing.

22. A throughflow member as claimed in claim 1, wherein the housing (1) is provided with one or more ribs (33) extending externally around the periphery of the housing to minimise the flow of liquid externally along the housing.

23. A throughflow member as claimed in claim 1, wherein the housing (1) is substantially triangular, the housing having a relatively low front region (2) and a relatively large rear region (3).

24. A throughflow member as claimed in claim 23, wherein the opening at the front region (2) of the housing (1) is provided in the front wall thereof.

25. A throughflow member as claimed in claim 23, wherein an inclined wall (5) of the housing (1) is provided with one or more projections (27) to assist securing the housing in a wall of a building.

26. A throughflow member as claimed in claim 23, wherein a receiving portion (21) for the valve (17) is formed as part of an inclined external wall (5) of the housing (1).

27. (canceled)

28. (canceled)

29. (canceled)
